(19) United States
(12) Patent Application Publication
(10) Pub. No.: US 2017/0282462 A1
(43) Pub. Date: Oct. 5, 2017

(54) METHOD FOR MANUFACTURING THREE-DIMENSIONAL SHAPED OBJECT

(71) Applicant: PANASONIC INTELLECTUAL PROPERTY MANAGEMENT CO., LTD., Osaka (JP)

(72) Inventors: Satoshi ABE, Osaka (JP); Isao FUWA, Osaka (JP); Masataka TAKENAMI, Aichi (JP)

(73) Assignee: PANASONIC INTELLECTUAL PROPERTY MANAGEMENT CO., LT D., Osaka (JP)

(21) Appl. No.: 15/513,665

(22) PCT Filed: Sep. 30, 2015
(86) PCT No.: PCT/JP2015/004991

§ 371 Date: Mar. 23, 2017

(30) Foreign Application Priority Data
Oct. 1, 2014 (JP) 2014-203435

(51) Int. Cl. B29C 67/00; B22F 3/105; B33Y 30/00

(52) U.S. Cl. CPC B29C 67/0092; B33Y 30/00; B29C 67/0062; B22F 3/1055; B29C 67/0077; B33Y 80/00

(57) ABSTRACT

In order to provide the method for manufacturing the three-dimensional shaped object which is capable of preventing the occurrence of the raised portion at the sintered portion or the melted and subsequently solidified portion by the irradiation of the light beam, there is provided a method for manufacturing a three-dimensional shaped object by alternate repetition of a step (i) forming a powder-layer and a step (ii) forming a solidified layer by irradiating a predetermined portion of the powder layer with a light beam, wherein the light beam-irradiated portion is vibrated in the step (ii).

### TECHNICAL FIELD

The disclosure relates to a method for manufacturing a three-dimensional shaped object. More particularly, the disclosure relates to a method for manufacturing a three-dimensional shaped object in which a formation of a solidified layer is performed by an irradiation of a powder layer with a light beam.

### BACKGROUND OF THE INVENTION

Heretofore, a method for manufacturing a three-dimensional shaped object by irradiating a powder material with a light beam has been known (such method can be generally referred to as “selective laser sintering method”). The method can produce the three-dimensional shaped object by an alternate repetition of a powder-layer forming and a solidified-layer forming on the basis of the following steps (i) and (ii):

(i) forming a powder layer; and

(ii) forming a solidified layer by irradiating a predetermined portion of the powder layer with a light beam

This kind of technology makes it possible to produce the three-dimensional shaped object with its complicated contour shape in a short period of time. The three-dimensional shaped object can be used as a metal mold in a case where an inorganic powder material (e.g., a metal powder material) is used as the powder material. While on the other hand, the three-dimensional shaped object can also be used as various kinds of models in a case where an organic powder material (e.g., a resin powder material) is used as the powder material.

Taking a case as an example wherein the metal powder is used as the powder material, and the three-dimensional shaped object produced therefrom is used as the metal mold, the selective laser sintering method will now be briefly described. As shown in FIGS. 9A-9C, a powder layer 22 with its predetermined thickness is firstly formed on a base plate 21 by a lateral-directional movement of a squeegee blade 23 (see FIG. 9A). Then, a predetermined portion of the powder layer is irradiated with a light beam L to form a solidified layer 24 (see FIG. 9B). Another powder layer is newly provided on the formed solidified layer, and is irradiated again with the light beam to form another solidified layer. In this way, the powder-layer forming and the solidified-layer forming are alternately repeated, and thereby allowing the solidified layers 24 to be stacked with each other (see FIG. 9C). The alternate repetition of the powder-layer forming and the solidified-layer forming leads to a production of a three-dimensional shaped object with a plurality of the solidified layers integrally stacked therein. The lowermost solidified layer 24 can be provided in a state of being adhered to the surface of the base plate 21. Therefore, there can be obtained an integration of the three-dimensional shaped object and the base plate. The integrated “three-dimensional shaped object” and “base plate” can be used as the metal mold.

### PATENT DOCUMENTS (RELATED ART PATENT DOCUMENTS)

### PATENT DOCUMENT 1: Japanese Unexamined Patent Application Publication No. 2004-143581

### DISCLOSURE OF THE INVENTION

### Problems to be Solved by the Invention

The inventors of the present application have found that a raised portion occurs at a sintered portion or a melted and subsequently solidified portion when the solidified layer is formed by irradiating the predetermined portion of the powder layer with the light beam, the sintered portion or the melted and subsequently solidified portion being obtained by the irradiation of the light beam. Specifically, the inventors of the present application have found that a plurality of the raised portions corresponding to a reference numeral 50 shown in an upper portion of FIGS. 1 and 11 occur at the sintered portion or the melted and subsequently solidified portion obtained by the irradiation of the light beam L such that a part of one of the plurality of the raised portions 50 overlaps with a part of other of the plurality of the raised portions 50, the plurality of the raised portions 50 (i) having the curved cross-sectional shape respectively and (ii) being adjacent to each other.

The forming of a new powder layer on the formed solidified layer results in the technical problems at a point in time when the raised portions occur. Specifically, the curved shape of each of the raised portions causes a difference between (i) a thickness of the new powder layer on a partially overlapping portion of the raised portions which are adjacent to each other, the thickness corresponding to h₁ of FIG. 11 and (ii) a thickness of the new powder layer on a top portion of each of the raised portions, the thickness corresponding to h₂ of FIG. 11. As a result, it is impossible to form the new powder layer with a predetermined uniform thickness as a whole.

More specifically, the curved shape results in the forming of a new powder layer in which the new powder layer on the partially overlapping portion of the raised portions adjacent to each other has a larger thickness than that of the new powder layer on the top portion of each of the raised portions, the thickness of the new powder layer on the partially overlapping portion corresponding to h₁ of FIG. 11, the thickness of the new powder layer on the top portion of each of the raised portions corresponding to h₂ of FIG. 11. The forming of a new solidified layer by an irradiation of a predetermined portion of the new powder layer having two different thicknesses with the light beam results in the technical problems. Specifically, the irradiation of the predetermined portion of the new powder layer having two different thicknesses with the light beam may cause a difference between (i) a solidified density of the new solidified layer near the partially overlapping portion of the raised portions adjacent to each other and (ii) a solidified density of the new solidified layer above the top portion of each of the raised portions, the region of the new solidified layer near the partially overlapping portion of the raised portions corresponding to a “M” region in FIG. 11, the region positioned above the top portion of each of the raised portions corresponding to a “N” region in FIG. 11. More specifically, the new powder layer on the partially overlapping portion of the raised portions which are adjacent to each other has the thickness-dimension which is larger than that of the new powder layer on the top portion of each of the raised portions. Thus, the “M” region may not sufficiently obtain an irradiation energy of the light beam, which may lead to a provision of the “M” region of the new solidified layer with its solidified density smaller than that of the “N” region in the new solidified layer. As a result, it may be difficult to form the new solidified layer with its uniform solidified density. Accordingly, it may be impossible to finally provide a three-dimensional shaped object with desired shape and quality.

Under these circumstances, an object of the present invention is to provide the method for manufacturing the three-dimensional shaped object which is capable of preventing the occurrence of the raised portion at the sintered portion or the melted and subsequently solidified portion obtained by the irradiation of the light beam.

### Means for Solving the Problems

In order to achieve the above object, an embodiment of the present invention provides a method for manufacturing a three-dimensional shaped object by alternate repetition of a step (i) forming a powder-layer and a step (ii) forming a solidified layer by irradiating a predetermined portion of the powder layer with a light beam,

wherein the light beam-irradiated portion is vibrated in the step (ii).

### Effect of the Invention

In the method for manufacturing the three-dimensional shaped object according to an embodiment of the present invention, a predetermined portion of the powder layer which is irradiated with the light beam is vibrated. Thus, it is possible to prevent the occurrence of the raised portion at the sintered portion or the melted and subsequently solidified portion obtained by the irradiation of the light beam. Thus, the solidified layer with its smooth surface can be formed, which allows the forming of the new powder layer with a desired uniform thickness on the formed solidified layer as a whole. As a result, the new solidified layer with its uniform solidified density can be formed when the new solidified layer is formed by the irradiation of the predetermined portion of the new powder layer with the light beam. Accordingly, the forming of the new solidified layer with its uniform solidified density makes it possible to finally provide the three-dimensional shaped object with desired shape and quality.

### BRIEF DESCRIPTION OF THE DRAWINGS

FIG. 1 is a perspective view schematically illustrating a state at a point in time when the predetermined portion of the powder layer is irradiated with the light beam.

FIG. 2 is a schematic view illustrating a technical concept of the present invention.

FIG. 3 is a cross-sectional view schematically illustrating an embodiment wherein a forming table and a base plate provided thereon are vibrated.

FIG. 4 is a cross-sectional view schematically illustrating an embodiment wherein the forming table and the base plate are vibrated by using a vibrator.

FIG. 5 is a cross-sectional view schematically illustrating an embodiment wherein a direct impact toward an upper direction is provided on a lower surface of the forming table by using a hammer to vibrate the forming table.

FIG. 6 is a cross-sectional view schematically illustrating an embodiment wherein the direct impact is provided on a side surface of the forming table by using the hammer to vibrate the forming table.

FIG. 7 is a top plan view schematically illustrating an embodiment wherein the direct impact is provided on the side surface of the forming table by using the hammer to vibrate the forming table.

FIG. 8 is a perspective view schematically illustrating a construction of a laser-sintering/machining hybrid machine.

FIGS. 9A-9C are each a cross-sectional view schematically illustrating a laser-sintering/machining hybrid process in accordance with the selective laser sintering method respectively.

FIG. 10 is a flow chart of general operations of a laser-sintering/machining hybrid machine.

FIG. 11 is a cross-sectional view schematically illustrating a state at a point in time when the predetermined portion of the powder layer is irradiated with the light beam, the view corresponding to a view in which technical problems found by the inventors of the present application are shown.

### MODES FOR CARRYING OUT THE INVENTION

The manufacturing method according to an embodiment of the present invention will be described in more detail with reference to the accompanying drawings. It should be noted that configurations/forms and dimensional proportions in the drawings are merely for illustrative purposes, and thus not the same as those of the actual parts or elements.

The term “powder layer” as used in this description and claims means a “metal powder layer made of a metal powder” or “resin powder layer made of a resin powder”, for example. The term “predetermined portion of a powder layer” as used herein substantially means a portion of a three-dimensional shaped object to be manufactured. As such, a powder present in such predetermined portion is irradiated with a light beam, and thereby the powder undergoes a sintering or a melting and subsequent solidification to form a shape of a three-dimensional shaped object. Furthermore, the term “solidified layer” substantially means a “sintered layer” in a case where the powder layer is a metal powder layer, whereas term “solidified layer” substantially means a “cured layer” in a case where the powder layer is a resin powder layer.

The term “upward/downward” direction directly or indirectly used herein corresponds to a direction based on a positional relationship between the base plate and the three-dimensional shaped object. A side for manufacturing the three-dimensional shaped object is defined as the “upward direction”, and a side opposed thereto is defined as the “downward direction” when using a position at which the base plate is provided as a standard.

### [Selective Laser Sintering Method]

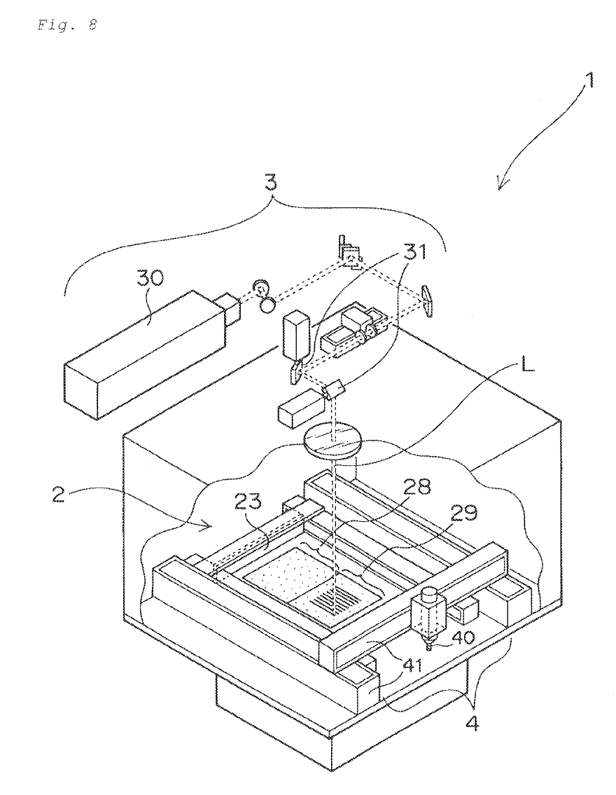

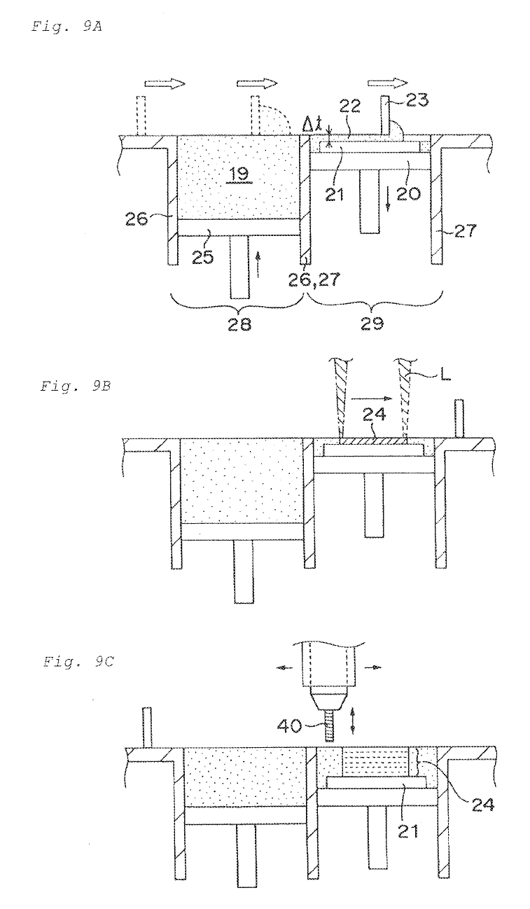

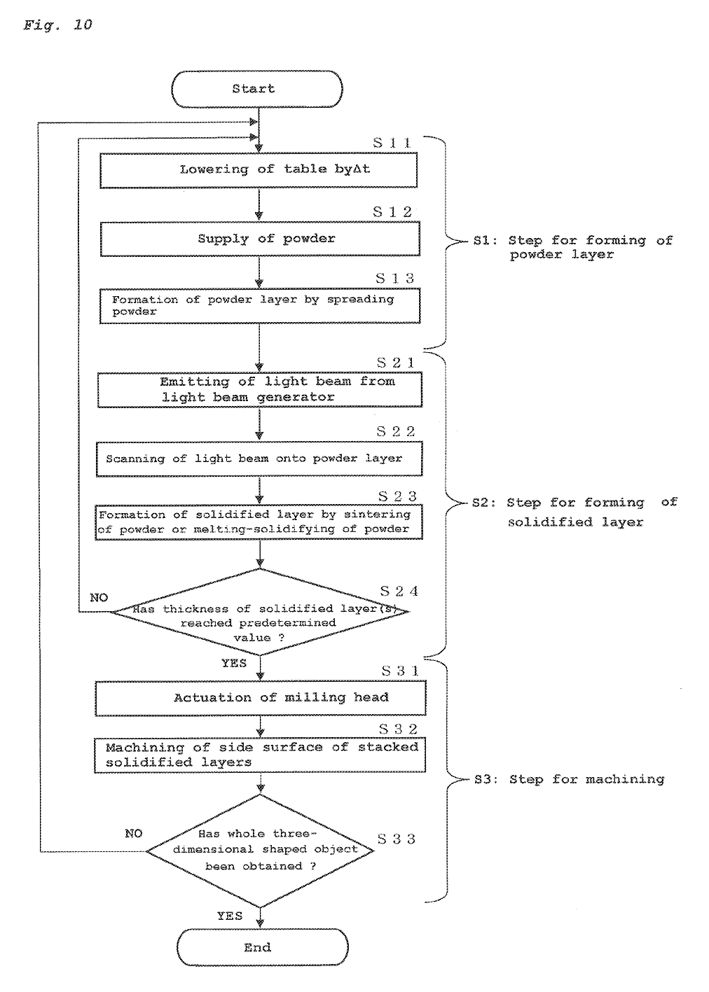

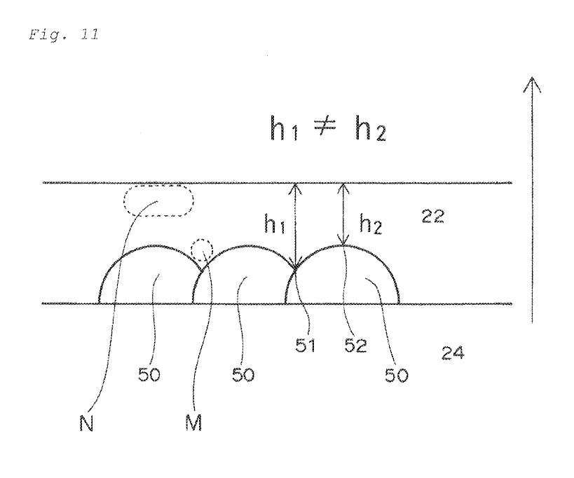

First of all, a selective laser sintering method, on which an embodiment of the manufacturing method of the present invention is based, will be described. By way of example, a laser-sintering/machining hybrid process wherein a machining is additionally carried out in the selective laser sintering method will be explained. FIGS. 9A-9C schematically show a process embodiment of the laser-sintering/machining hybrid. FIGS. 8 and 10 respectively show major constructions and operation flow regarding a metal laser sintering hybrid milling machine for enabling an execution of a machining process as well as the selective laser sintering method.

As shown in FIG. 8, the laser-sintering/milling hybrid machine 1 is provided with a powder layer former 2, a light-beam irradiator 3, and a machining means 4.

The powder layer former 2 is a means for forming a powder layer with its predetermined thickness through a supply of powder (e.g., a metal powder or a resin powder) as shown in FIGS. 9A-9C. The light-beam irradiator 3 is a means for irradiating a predetermined portion of the powder layer with a light beam “L”. The machining means 4 is a means for milling the side surface of the stacked solidified layers, i.e., the surface of the three-dimensional shaped object.

As shown in FIGS. 8 and 9A-9C, the powder layer former 2 is mainly composed of a powder table 25, a squeegee blade 23, a forming table 20 and a base plate 21. The powder table 25 is a table capable of vertically elevating/descending in a “storage tank for powder material” 28 whose outer periphery is surrounded with a wall 26. The squeegee blade 23 is a blade capable of horizontally moving to spread a powder 19 from the powder table 25 onto the forming table 20, and thereby forming a powder layer 22. The forming table 20 is a table capable of vertically elevating/descending in a forming tank 29 whose outer periphery is surrounded with a wall 27. The base plate 21 is a plate for a shaped object. The base plate is disposed on the forming table 20 and serves as a platform of the three-dimensional shaped object.

As shown in FIG. 8, the light-beam irradiator 3 is mainly composed of a light beam generator 30 and a galvanometer mirror 31. The light beam generator 30 is a device for emitting a light beam “L”. The galvanometer mirror 31 is a means for scanning an emitted light beam “L” onto the powder layer, i.e., a scan means of the light beam “L”.

As shown in FIG. 8, the machining means 4 is mainly composed of a milling head 40 and an actuator 41. The milling head 40 is a cutting tool for milling the side surface of the stacked solidified layers, i.e., the surface of the three-dimensional shaped object. The actuator 41 is a means for driving the milling head 40 to move toward the position to be milled.

Operations of the laser sintering hybrid milling machine 1 will now be described in detail. As can been seen from the flowchart of FIG. 10, the operations of the laser sintering hybrid milling machine are mainly composed of a powder layer forming step (S1), a solidified layer forming step (S2), and a machining step (S3). The powder layer forming step (S1) is a step for forming the powder layer 22. In the powder layer forming step (S1), first, the forming table 20 is descended by Δt (S11), and thereby creating a level difference Δt between an upper surface of the base plate 21 and an upper-edge plane of the forming tank 29. Subsequently, the powder table 25 is elevated by Δt, and then the squeegee blade 23 is driven to move from the storage tank 28 to the forming tank 29 in the horizontal direction, as shown in FIG. 9A. This enables a powder 19 placed on the powder table 25 to be spread onto the base plate 21 (S12), while forming the powder layer 22 (S13). Examples of the powder for the powder layer include a “metal powder having a mean particle diameter of about 5 μm to 100 μm” and a “resin powder having a mean particle diameter of about 30 μm to 100 μm (e.g., a powder of nylon, polypropylene, ABS or the like”. Following this step, the solidified layer forming step (S2) is performed. The solidified layer forming step (S2) is a step for forming a solidified layer 24 through the light beam irradiation. In the solidified layer forming step (S2), a light beam “L” is emitted from the light beam generator 30 (S21). The emitted light beam “L” is scanned onto a predetermined portion of the powder layer 22 by means of the galvanometer mirror 31 (S22). The scanned light beam can cause the powder in the predetermined portion of the powder layer to be sintered or be melted and subsequently solidified, resulting in a formation of the solidified layer 24 (S23), as shown in FIG. 9B. Examples of the light beam “L” include carbon dioxide gas laser, Nd:YAG laser, fiber laser, ultraviolet light, and the like.

The powder layer forming step (S1) and the solidified layer forming step (S2) are alternately repeated. This allows a plurality of the solidified layers 24 to be integrally stacked with each other, as shown in FIG. 9C.

When the thickness of the stacked solidified layers 24 reaches a predetermined value (S24), the machining step (S3) is initiated. The machining step (S3) is a step for milling the side surface of the stacked solidified layers 24, i.e., the surface of the three-dimensional shaped object. The milling head 40 (see FIG. 9C and FIG. 10) is actuated to initiate an execution of the machining step (S31). For example, in a case where the milling head 40 has an effective milling length of 3 mm, a machining can be performed with a milling depth of 3 mm. Therefore, supposing that “At” is 0.05 mm, the milling head 40 is actuated when the formation of the sixty solidified layers 24 is completed. Specifically, the side face of the stacked solidified layers 24 is subjected to the surface machining (S32) through a movement of the milling head 40 driven by the actuator 41. Subsequent to the surface machining step (S3), it is judged whether or not the whole three-dimensional shaped object has been obtained (S33). When the desired three-dimensional shaped object has not yet been obtained, the step returns to the powder layer forming step (S1). Thereafter, the steps S1 through S3 are repeatedly performed again wherein the further stacking of the solidified layers 24 and the further machining process therefor are similarly performed, which eventually leads to a provision of the desired three-dimensional shaped object.

### [Manufacturing Method of the Present Invention]

A manufacturing method according to an embodiment of the present invention is characterized by features associated with a formation of the solidified layer 24 by the irradiation of the predetermined portion of the powder layer 22 with the light beam L in the selective laser sintering method as described above.

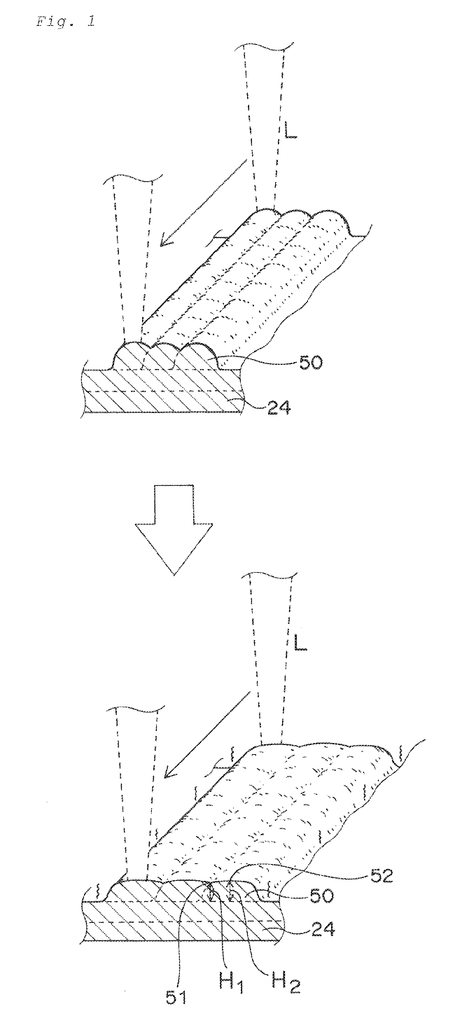

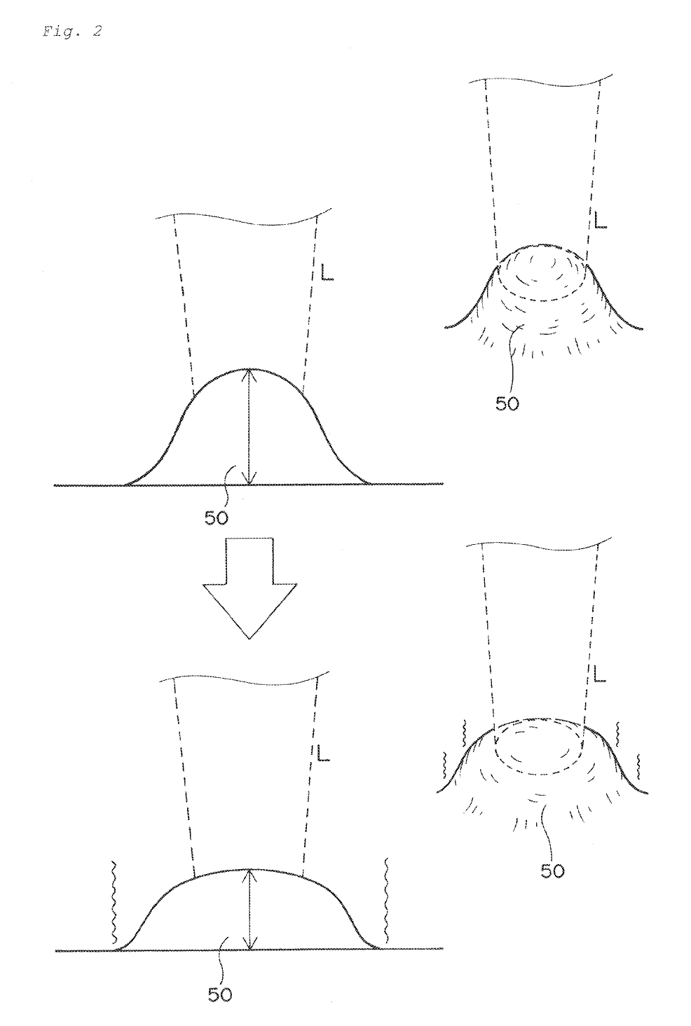

FIG. 1 is the perspective view schematically illustrating a state at a point in time when the predetermined portion of the powder layer 22 is irradiated with the light beam L. FIG. 2 is the schematic view illustrating that a sintered portion or a melted and subsequently solidified portion at which the raised portion occurs is vibrated, the sintered portion or the melted and subsequently solidified portion being obtained by the irradiation of the light beam L. FIG. 11 is a cross-sectional view schematically illustrating a state at a point in time when the predetermined portion of the powder layer 22 is irradiated with the light beam L, the view corresponding to a view in which technical problems found by the inventors of the present application are shown.

Firstly, a technical concept of the present invention will be described with reference to FIG. 2 in order to prompt the understanding of the present invention. A principal characteristic of the present invention is that a portion irradiated with the light beam L, which is referred to as a light beam-irradiated portion, is vibrated. The details will now be described. Due to the vibration of the light beam-irradiated portion (see an upper portion of FIG. 2), a height of the raised portion can be decreased compared to that of the raised portion with no vibration of the light beam-irradiated portion (see a lower portion of FIG. 2). The phrase “raised portion” as used herein indicates a light beam-irradiated portion in a form of a bulge toward an upper direction, the bulge having the curved cross-sectional shape, the light beam-irradiated portion corresponding to the predetermined portion of the powder layer 22 irradiated with the light beam L.

The manufacturing method according to an embodiment of the present invention will be hereinafter described in detail.

As shown in the upper portion of FIGS. 1 and 11, the inventors of the present application have found that the raised portion 50 occurs at a sintered portion or a melted and subsequently solidified portion when the solidified layer 24 is formed by irradiating the predetermined portion of the powder layer 22 with the light beam L, the sintered portion or the melted and subsequently solidified portion being obtained by the irradiation of the light beam L. Specifically, as shown in the upper portion of FIGS. 1 and 11, the inventors of the present application have found that a plurality of the raised portions 50 occur at the sintered portion or the melted and subsequently solidified portion obtained by the irradiation of the light beam L such that a part of one of the plurality of the raised portions 50 overlaps with a part of other of the plurality of the raised portions 50, the plurality of the raised portions 50 (i) having the curved cross-sectional shape respectively and (ii) being adjacent to each other.

As shown in FIG. 11, the forming of a new powder layer 22 on the formed solidified layer 24 results in the technical problems at a point in time when the raised portions 50 occur. Specifically, the curved shape of each of the raised portions 50 causes the difference between (i) the thickness (i.e., h₁ in FIG. 11) of the new powder layer 22 on the partially overlapping portion 51 of the raised portions 50 which are adjacent to each other and (ii) the thickness (i.e., h₂ in FIG. 11) of the new powder layer 22 on the top portion 52 of each of the raised portions 50. As a result, it is impossible to form the new powder layer 22 with its predetermined uniform thickness as a whole. More specifically, as shown in FIG. 11, the curved shape of the raised portion 50 results in the forming of a new powder layer 22 in which the new powder layer 22 on the partially overlapping portion 51 of the raised portions 50 adjacent to each other has a larger thickness than that of the new powder layer 22 on the top portion 52 of each of the raised portions 50. The forming of the new solidified layer 24 by the irradiation of the predetermined portion of the new powder layer 22 having two different thicknesses with the light beam L results in the technical problems. Specifically, the irradiation of the predetermined portion of the new powder layer having two different thicknesses with the light beam may cause the difference between (i) the solidified density of the new solidified layer 24 near the partially overlapping portion 51 of the raised portions 50 adjacent to each other and (ii) the solidified density of the new solidified layer 24 near the top portion 52 of each of the raised portions 50. More specifically, since the new powder layer 22 on the partially overlapping portion 51 of the raised portions 50 adjacent to each other has the thickness-dimension which is larger than that of the new powder layer 22 on the top portion 52 of each of the raised portions 50, the following technical problems occur. Specifically, the irradiation energy of the light beam L may be not sufficiently provided in a region (i.e., “M” region of FIG. 11) near the partially overlapping portion 51 of the raised portions 50 adjacent to each other, which may lead to the provision of the region (i.e., “M” region of FIG. 11) near the partially overlapping portion 51 with its solidified density smaller than that of the region (i.e., “N” region of FIG. 11) above the top portion 52. As a result, it may be difficult to form the new solidified layer 24 with its uniform solidified density. Accordingly, it may be impossible to finally provide the three-dimensional shaped object with the desired shape and quality.

In light of the above matters, the inventors of the present application have extensively studied a method for preventing the occurrence of the raised portion 25. As a result, as shown in a lower portion of FIG. 1, the inventors of the present application have created that a predetermined portion of the powder layer 22 irradiated with the light beam L is vibrated. Specifically, the inventors of the present application have created that a portion irradiated with the light beam L is vibrated when the predetermined portion of the powder layer 22 is irradiated with the light beam L. The phrase “the portion irradiated with the light beam is vibrated” as used herein means that the predetermined portion of the powder layer 22 is vibrated while being irradiated with the light beam L or during the irradiation of the predetermined portion of the powder layer 22 with the light beam L.

The portion irradiated with the light beam L is vibrated when the predetermined portion of the powder layer 22 is irradiated with the light beam L in the present invention, which can make the following advantageous effects.

Specifically, when the predetermined portion of the powder layer 22 is irradiated with the light beam L, a fluidity portion is formed at the portion irradiated with the light beam L, the fluidity portion being called “melt pool”. A continuous vibration of the fluidity portion allows a decrease of a height of the fluidity portion and an increase of a width of the fluidity portion due to a property of the fluidity portion compared to the height of the fluidity portion and the width of the fluidity portion with no vibration of the fluidity portion, which makes it possible to prevent the occurrence of the raised portion 50 at the sintered portion or the melted and subsequently solidified portion obtained by the irradiation of the light beam L. Accordingly, the prevention of the occurrence of the raised portion 50 allows a formation of the solidified layer 24 with its smooth surface. The phrase “solidified layer with its smooth surface” as used herein means a solidified layer having a difference (i.e., H₂−H₁) between (i) a height H₁ of the partially overlapping portion 51 of a raised portions 50 which are adjacent to each other (see the lower portion of FIG. 1), the raised portions 50 being formed on the solidified layer 24 and (ii) a height H₂ of the top portion 52 of each of the raised portions 50 (see the lower portion of FIG. 1) of less than 20%, preferably less than 10%, more preferably less than 5%. A vibration of the portion irradiated with the light beam L is performed with a frequency of 0.1 kHz to 1000 kHz, preferably 1 kHz to 100 kHz. As described below, the vibration with such the frequency can be provided by using a vibrator and/or a hammer (or hammer part), for example.

As described above, the three-dimensional shaped object to be finally obtained is comprised of the laminated solidified layers 24. In the selective laser sintering method, the entire solidified layers 24 for forming a new powder layer 22 thereon have a non-constant and gradually varying shape and/or mass. It can be presumed that the non-constant and gradually varying shape and/or mass of the entire solidified layers 24 lead to a gradual variance of a natural frequency or an inherent frequency of the entire solidified layers 24 for forming the new powder layer 22 thereon. The phrase “inherent frequency” as used herein means a frequency generating a phenomenon of a “sympathetic vibration” which causing a large oscillation or swing due to an increased vibration. In light of the above matters, it is more preferable that the portion irradiated with the light beam L is vibrated on a basis of the natural frequency which is in accordance with the shape and/or mass of the entire solidified layers 24 for forming the new powder layer 22 thereon. The natural frequency can be provided by a suitable process. According to an example of the optional process, the natural frequency can be calculated by a simulation analysis with a software for a structural analysis based on an information on the shape and/or mass of the entire solidified layers 24 (i.e., a precursor of the three-dimensional shaped object) just before forming the new powder layer 22.

As described above, the phenomenon of the “sympathetic vibration” which causing the large oscillation due to the increased vibration results from a provision of substantially the same frequency as the natural frequency in accordance with the shape and/or mass of the entire solidified layers 24 for forming the new powder layer 22 thereon. The phenomenon of the “sympathetic vibration” allows the fluidity portion formed at the portion irradiated with the light beam L to be effectively vibrated. Therefore, the effective vibration of the fluidity portion allows a “further decrease” of the height of the fluidity portion and a “further increase” of the width of the fluidity portion due to the property of the fluidity portion compared to the height of the fluidity portion and the width of the fluidity portion with no vibration of the fluidity portion.

Thus, the solidified layer 24 with a smooth surface can be formed, which allows the forming of the new powder layer 22 with a desired uniform thickness on the formed solidified layer 24 as a whole. As a result, the new solidified layer 24 with its uniform solidified density can be formed when it is formed by the irradiation of the predetermined portion of the new powder layer 22 with the light beam L. Accordingly, the forming of the new solidified layer 24 with its uniform solidified density makes it possible to finally provide the three-dimensional shaped object with desired shape and quality.

Furthermore, the present invention can make the following advantageous effects.

In the sintered portion or the melted and subsequently solidified portion by the irradiation of the predetermined portion of the powder layer 22 with the light beam L, spaces existing in the powder layer 22 are decreased, which leads to an occurrence of a shrinkage phenomenon. Since the raised portion 50 occurs at the sintered portion or the melted and subsequently solidified portion by the irradiation with the light beam L, it is presumed that the shrinkage phenomenon occurs at the raised portion 50. Thus, the shrinkage phenomenon may cause a concentration of a stress oriented to an inside direction of the raised portion 50. As a result, the concentration of the stress may cause a warp and/or a deformation of the solidified layers 24, i.e., the three-dimensional shaped object to be finally manufactured. In light of the above matters, the portion irradiated with the light beam L is vibrated, which leads to a decrease in the concentration of the stress oriented to the inside direction of the raised portion 50. Accordingly, the decrease in the concentration of the stress makes it possible to prevent the occurrence the warp and/or the deformation of the three-dimensional shaped object to be finally manufactured.

Furthermore, the prevention of the occurrence of the raised portion 50 in the present invention allows a region to be irradiated with the light beam L to be increased, the region substantially corresponding to the predetermined portion of the powder layer 22. Specifically, the prevention of the occurrence of the raised portion 50 allows the irradiation of the predetermined portion of the powder layer 22 with the light beam L with a large pitch of scan. Accordingly, a time for forming the solidified layers 24, i.e., a time for manufacturing the three-dimensional shaped object can be shortened, which contributes to an improvement of a manufacturing efficiency of the three-dimensional shaped object.

It is preferable that the manufacturing method according to an embodiment of the present invention adopts the following aspects when the following solidified layer 24 is formed.

Specifically, when forming the solidified layer 24 of “a high-density portion with its solidified density of 95 to 100%” and “a low-density portion with its solidified density of 0 to 95% (excluding 95%)”, it is preferable that the high-density portion formed by the irradiation with the light beam L is positively vibrated.

An irradiation condition of the light beam L used for a formation of the high-density portion is different from that used for the formation of the low-density portion. Specifically, the formation of the high-density portion is performed by a use of the light beam L having an irradiation energy higher than that of the light beam L used for the formation of the low-density portion. Due to the use of the light beam L having the higher irradiation energy, the raised portion 50 at the high-density portion may have a height higher than that of the raised portion 50 at the low-density portion. In light of the above matters, it is preferable that the high-density portion formed by the irradiation with the light beam L is vibrated. Thus, the vibration of the high-density portion makes it possible to preferably prevent the occurrence of the raised portion 50. The phrase “solidified density (%)” as used herein substantially means a solidified sectional density (an occupation-ratio of a solidified material) determined by an image processing of a sectional photograph of the three-dimensional shaped object. Image processing software for determining the solidified sectional density is Scion Image ver. 4.0.2 (freeware made by Scion). In such case, it is possible to determine a solidified sectional density ρₛ from the below-mentioned equation 1 by binarizing a sectional image into a solidified portion (white) and a vacancy portion (black), and then counting all picture element numbers Pxₐ₁₁ of the image and picture element number PX_{white} of the solidified portion (white).

$${ρ}_{S} = \frac{{Px}_{white}}{{Px}_{all}} 100 ( \% ) \qquad [ Equation 1 ]$$

A method for vibrating the predetermined portion of the powder layer 22 irradiated with the light beam L will now be described.

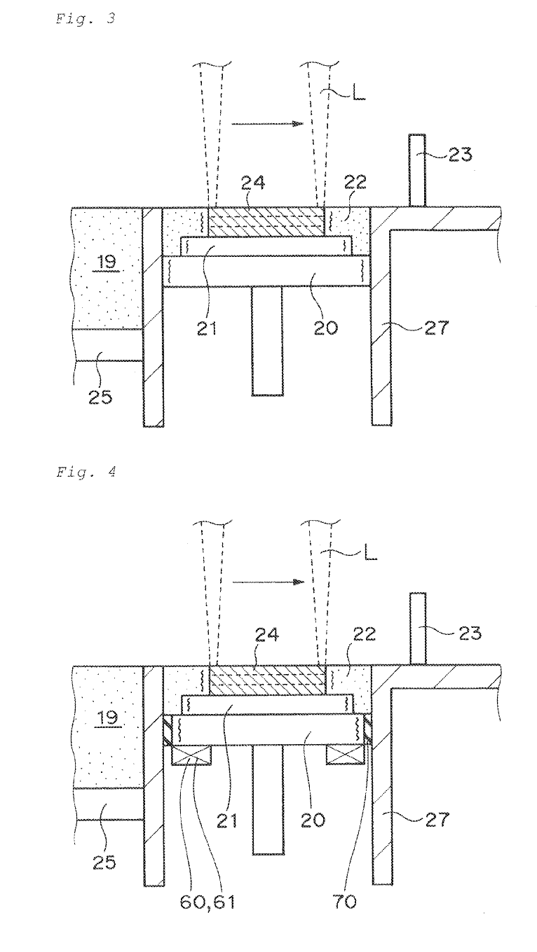

FIG. 3 is the cross-sectional view schematically illustrating an embodiment wherein the forming table 20 and the base plate 21 provided on the forming table 20 are vibrated.

As shown in FIG. 3, the base plate 21 is provided on the forming table 20. The solidified layer 24 formed by the irradiation of the predetermined portion of the powder layer with the light beam L is provided on the base plate 21. In an embodiment, the forming table 20 and the base plate 21 provided on the forming table 20 are vibrated. In this embodiment, the vibration of the forming table 20 and the base plate 21 is provided with respect to the portion irradiated with the light beam L. The use of the forming table 20 and the base plate 21 for the manufacturing of the three-dimensional shaped object has an advantage in that the vibration of the portion irradiated with the light beam L can be performed without using a separate vibration or an independent machine. A whole of the forming table 20 and the base plate 21 may be vibrated.

A method for vibrating the forming table 20 and the base plate 21 provided on the forming table 20 will now be described.

FIG. 4 is the cross-sectional view schematically illustrating an embodiment wherein the forming table 20 and the base plate 21 on the forming table 20 are vibrated by using the vibrator 60.

As shown in FIG. 4, methods for vibrating the forming table 20 and the base plate 21 on the forming table 20 include a use of the vibrator 60 provided on the forming table 20.

The use of the vibrator 60 results in the vibration of the forming table 20, which leads to a vibration of the base plate 21 directly provided on the forming table 20. Due to the vibration of the base plate 21, the portion irradiated with the light beam is vibrated. While not being limited to use of the vibrator on the forming table 20, the vibrator 60 is directly provided on the base plate 21, for example. It is preferable that the vibration of 0.1 kHz to 1000 kHz is provided by the use of the vibrator 60. It is more preferable that the vibration of 1 kHz to 100 kHz is provided by the use of the vibrator 60.

An ultrasonic vibrator 61 can be used as the vibrator 60, for example. The phrase “ultrasonic vibrator 61” described herein indicates a piezoelectric ceramic disposed between electrodes in which a voltage is applied to be repeatedly elongated and contracted for a provision of a vibration. The piezoelectric ceramic is a polycrystalline ceramic obtained by sintering such as titanium oxide, barium oxide, the polycrystalline ceramic being subjected to a polarization process. The phrase “ultrasonic” indicates an acoustic wave having the frequency of more than 16000 Hz.

In an embodiment, the vibrator 60 is provided on a lower surface of the forming table 20 as shown in FIG. 4. While not being limited to the provision of the vibrator 60 on the lower surface of the forming table 20, the vibrator 60 is preferably provided on a side surface of the forming table 20. A provision of the vibrator 60 on the side surface of the forming table 20 allows not a vertical-directional vibration of the forming table 20, but a lateral-directional vibration (i.e., horizontal-directional vibration) of the forming table 20. Thus, the lateral-directional vibration of the forming table 20 allows a diffusion of powder materials of the powder layer 22 into an atmosphere to be prevented. As shown in FIG. 4, in a case where the vibrator 60 is provided on the forming table 20, it is preferable that a part 70 for absorbing the vibration is provided between the forming table 20 and the wall 27 in order not to vibrate peripheral devices such as the powder table 25. The part 70 for absorbing the vibration includes a spring and a rubber part, for example.

The method for vibrating the forming table 20 and the base plate 21 provided on the forming table 20 can include the following embodiments without being limited to the above embodiment wherein the vibrator 60 is used.

FIG. 5 is the cross-sectional view schematically illustrating an embodiment wherein a direct impact toward an upper direction is provided on the lower surface 200 of the forming table 20 by using a hammer 80 (or hammer part) to vibrate the forming table. The phrase “upper direction” as used herein means a direction in which the three-dimensional shaped object is manufactured on the basis of the base plate 21 as described above. The phrase “hammer” as used herein means a tool for impacting an object to push the object or to deform it.

As shown in FIG. 5, the direct impact toward the upper direction may be provided on the lower surface 200 of the forming table 20 by using the hammer 80 in order to vibrate the forming table 20 and the base plate 21 on the forming table 20. It is preferable that the vibration of 0.1 kHz to 1000 kHz is provided by the use of the hammer 80. It is more preferable that the vibration of 1 kHz to 100 kHz is provided by the use of the hammer 80. As shown in FIG. 5, in a case where the direct impact is provided on the forming table 20 by the hammer 80 to vibrate the forming table 20, it is preferable that the part 70 for absorbing the vibration is provided between the forming table and the wall 27 in order not to vibrate the peripheral devices. The part 70 for absorbing the vibration includes the spring and the rubber part, for example.

It is more preferable that the hammer 80 for vibrating the forming table 20 and the base plate 21 on the forming table 20 is used as follows.

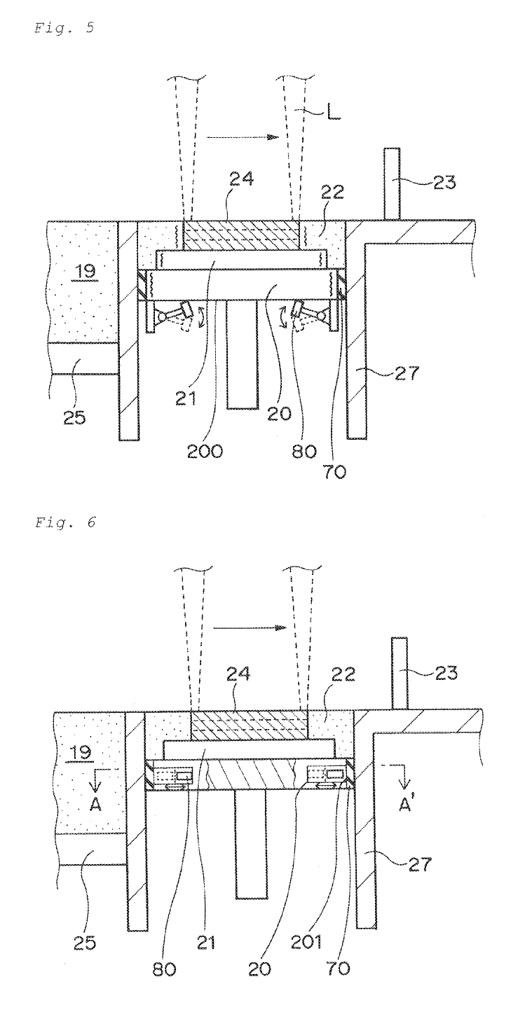

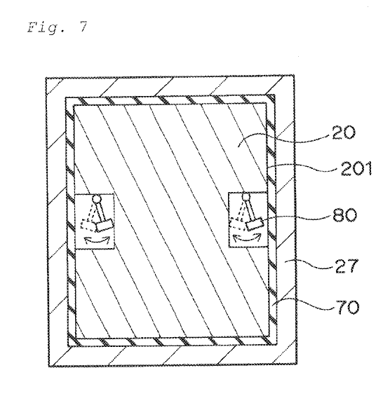

FIG. 6 is the cross-sectional view schematically illustrating an embodiment wherein the direct impact is provided on a side surface 201 of the forming table 20 by using the hammer 80 to vibrate the forming table. FIG. 7 is the top plan view schematically illustrating an embodiment wherein the direct impact is provided on the side surface 201 of the forming table 20 by using the hammer 80 to vibrate the forming table. FIG. 7 is the top plan view along a line A-A′ of FIG. 6.

In a case where the direct impact toward the upper direction is provided on the lower surface 200 of the forming table 20 by the hammer 80 to vibrate the forming table, the vibration by the hammer 80 may cause a diffusion of powder materials of the powder layer 22 into an atmosphere. In light of the above matters, it is preferable that the direct impact is provided on the side surface 201 of the forming table 20 by using the hammer 80 in order to prevent the diffusion of the powder materials into the atmosphere as shown in FIGS. 6 and 7. Namely, it is preferable that not a vertical-directional vibration of the forming table 20 but a lateral-directional vibration (i.e., horizontal-directional vibration) of the forming table 20 is performed. As shown in FIGS. 6 and 7, in a case where the direct impact is provided on the forming table 20 by the hammer 80 to vibrate the forming table 20, it is preferable that the part 70 for absorbing the vibration is provided between the forming table 20 and the wall 27 in order not to vibrate the peripheral devices. The part 70 for absorbing the vibration includes the spring and the rubber part, for example.

Although the method for manufacturing the three-dimensional shaped object according to an embodiment of the present invention has been hereinbefore described, the present invention is not limited to the above embodiments. It will be readily appreciated by the skilled person that various modifications are possible without departing from the scope of the present invention.

It should be noted that the present invention as described above includes the following aspects.

### The First Aspect:

A method for manufacturing a three-dimensional shaped object by alternate repetition of a step (i) forming a powder-layer and a step (ii) forming a solidified layer by irradiating a predetermined portion of the powder layer with a light beam,

wherein the light beam-irradiated portion is vibrated in the step (ii).

### The Second Aspect:

The method according to the first aspect, wherein the powder layer and the solidified layer are formed on a base plate, the base plate being provided on a forming table, and

wherein the forming table is subjected to a vibration and thereby causing the light beam-irradiated portion to be irradiated.

### The Third Aspect:

The method according to the second aspect, wherein the vibration of the forming table is performed by a vibrator of the forming table.

### The Fourth Aspect:

The method according to the third aspect, wherein an ultrasonic vibrator is used as the vibrator.

### The Fifth Aspect:

The method according to the second aspect or the third aspect, wherein a lateral-directional vibration of the forming table is performed.

### The Sixth Aspect:

The method according to any one of the first to fifth aspects, wherein the vibration of the light beam-irradiated portion is performed on the basis of a natural frequency which is in accordance with a shape of the solidified layer.

### INDUSTRIAL APPLICABILITY

The manufacturing method according to an embodiment of the present invention can provide various kinds of articles. For example, in a case where the powder layer is a metal powder layer (i.e., an inorganic powder layer) and thus the solidified layer corresponds to a sintered layer, the three-dimensional shaped object obtained by an embodiment of the present invention can be used as a metal mold for a plastic injection molding, a press molding, a die casting, a casting or a forging. While on the other hand in a case where the powder layer is a resin powder layer (i.e., an organic powder layer) and thus the solidified layer corresponds to a cured layer, the three-dimensional shaped object obtained by an embodiment of the present invention can be used as a resin molded article.

### CROSS REFERENCE TO RELATED PATENT APPLICATION

The present application claims the right of priority of Japanese Patent Application No. 2014-203435 (filed on Oct. 1, 2014, the title of the invention: “METHOD FOR MANUFACTURING THREE-DIMENSIONAL SHAPED OBJECT”), the disclosure of which is incorporated herein by reference.

### EXPLANATION OF REFERENCE NUMERALS

20 Forming table
21 Base plate
22 Powder layer
24 Solidified layer
60 Vibrator
61 Ultrasonic vibrator
L Light beam

1-6. (canceled)

7. A method for manufacturing a three-dimensional shaped object by alternate repetition of a step (i) forming a powder-layer and a step (ii) forming a solidified layer by irradiating a predetermined portion of the powder layer with a light beam,
wherein the predetermined portion of the powder layer is vibrated while being irradiated with the light beam in the step (ii).

8. The method according to claim 7, wherein the powder layer and the solidified layer are formed on a base plate, the base plate being provided on a forming table, and
wherein the forming table is subjected to a vibration, and thereby causing the predetermined portion of the powder layer to be vibrated.

9. The method according to claim 8, wherein the vibration of the forming table is performed by a vibrator of the forming table.

10. The method according to claim 9, wherein an ultrasonic vibrator is used as the vibrator.

11. The method according to claim 8, wherein a lateral-directional vibration of the forming table is performed.

12. The method according to claim 7, wherein the vibration of the predetermined portion of the powder layer is performed on the basis of a natural frequency which is in accordance with a shape of the solidified layer.
